(19) United States
(12) Patent Application Publication
(10) Pub. No.: US 2007/0170354 A1
(43) Pub. Date: Jul. 26, 2007

(54) Light grid

(76) Inventors: Stephan Schmitz, Freiburg (DE); Heinrich Hippenmeyer, Freiamt (DE); Ulrich Zwoelfer, Kenzingen (DE)

Correspondence Address: THE NATH LAW GROUP, 112 South West Street, Alexandria, VA, 22314, US

(21) Appl. No.: 11/657,116

(22) Filed: Jan. 24, 2007

(30) Foreign Application Priority Data
Jan. 26, 2006 (DE) 10 2006 003 954.8

(51) Int. Cl. G01B 9/10

(52) U.S. Cl. 250/227.29

(57) ABSTRACT

A light grid can be constructed with individual modules (10). Each module (10) is an independent functional transmitter and/or receiver unit in an enclosed housing (12). The modules (10) can be coupled to each other in series in a galvanically separate manner for purposes of energy and/or signal transmission.

This invention concerns a light grid in accordance with the principal concept of claim 1.

Light grids have several light rays defined by light emitters and light receptors and are in particular used for object recognition, for determining the height or length of objects and for detecting irregular objects. It is necessary, in particular for area monitoring, e.g. hazardous areas, to adapt the light grid to the different conditions and spatial proportions of the area which is to be monitored. To achieve this, it is known from US 2001/0040213 A1 to construct a light grid consisting of individual modules, with each module having an enclosed housing in which transmitter or receiver units are located. The modules are coupled to each other in order to construct the light grid. It is possible to interconnect the modules in a linear or angled fashion for purposes of adapting them to the particular application. In the process it is possible to make a rigid connection, a connection via flexible cables, as well as a swiveling connection via a rotary coupling. The modules attached to each other are then coupled to each other via a galvanic connector. The power supply for the light emitters and the receivers on the one hand, and the signals for controlling the light emitters and receivers and for processing the received information on the other hand are transmitted through this connector. The mechanical connectors used for galvanic coupling are subject to wear, particularly if these connectors are designed so they can be rotated.

It is the object of this invention to provide a light grid of the kind specified above in such a way that a versatile configuration of the light grid is achievable in a robust embodiment.

This task is accomplished according to this invention by means of a light grid with the characteristics of claim 1.

Advantageous embodiments of this invention are described in the secondary claims.

According to this invention, an optoelectronic light grid is constructed from individual modules. Each module has an enclosed housing in which the transmitter unit or the receiver unit respectively is located. The individual modules are coupled to each other without a galvanic connection. Inductive, capacitive or optical transducers can be used for this purpose. It is via these transducers that the power for the electronics is supplied to the respective module. These transducers furthermore transmit the signals and the data used to control the transmitter and receiver units and to transfer the information collected by the light grid to a central processing device.

Transducer interfaces, which are configured as mating surfaces on the exterior of the housing, are located on the housing of the modules. These mating surfaces are brought into contact for purposes of coupling the modules to each other, with the result that the transducer interfaces located in the modules that are coupled to each other complement each other to form a complete transducer. Since no galvanic connector contacts are present, these transducer interfaces are designed as smooth surfaces of the housing, which are impervious to dirt, humidity and other environmental influences. The modules and the light grid constructed with them is therefore particularly robust and also suitable for use under difficult environmental conditions.

The modules may be configured as transmitter modules and receiver modules containing respectively only one unit, i.e. only light emitters or light receptors with the associated electronics. It is also possible to equip modules with transmitter and receiver units so that, for example, light emitters and light receptors are arranged alternately. The design of the transmitter and/or receiver units in the modules corresponds to the known design for optoelectronic light grids.

The individual modules have two transducer interfaces each allowing the modules to be connected in series. The supplied power is thereby passed from one module to the next. Signal and data transmission preferably occurs via a bus system that passes via the coupling of the modules through the entire arranged series of modules. Since each module constitutes an independently functional unit, it is possible in such a bus system to assemble and couple an arbitrary number of modules. For example, a light grid may be constructed from a set of transmitter modules and an opposite set of receiver modules. Similarly, transmitter modules and receiver modules may be attached to each other and coupled alternately. This provides a considerable advantage in production since only a few basic modules are needed, allowing the construction of light grids whose size and design is applicable to a wide variety of requirements. Each module can be tested separately for its operability before it is installed, which further simplifies production and improves reliability. Even in installed light grids the modular structure allows for simple error detection and fast and simple repair by replacing the defective module. By means of the bus system each module can determine its position within the overall system and it can accordingly be activated by the control system. This is possible both in the installation of a complicated light grid and in the reconfiguration or exchange for purposes of repair.

The geometrical configuration of the sequential modules depends on the configuration and design of the transducer interfaces. If the mating surfaces of the transducer interfaces are arranged perpendicular to the longitudinal axis of the module, the modules can be interconnected along a straight line. This is the simplest configuration of a light grid. If the light grid is to exhibit an angular configuration for the purpose of conforming to the spatial conditions, the mating surfaces can be arranged according at the desired angle between successive modules. If a high degree of flexibility in the alignment of the successive modules is desired, the housings preferably can be rotated in relation to each other in the plane of the mating surface about an axis that is perpendicular to the mating surface in order to achieve different angular positions of the sequential modules. Since the modules with flat mating surfaces adjoin each other, this ability to rotate does not imply a more complicated housing structure. It is only necessary for the transducer interface to be positioned symmetrically to the rotation with respect to the axis of rotation.

In one preferred embodiment there is an inductive coupling of the modules. In this case the transducer interfaces are formed by a part of the magnetic core of the inductive transducer. The magnetic cores are positioned in the housing at the respective mating surface in such a way that they complement each other so as to form the complete magnet core of the transducer when the mating surfaces of the modules adjoin each other.

In case of a capacitive coupling, a capacitor plate is placed in the mating surfaces of the housing so that, on joining the mating surfaces, the capacitor plates jointly form the coupling condenser of the capacitive transducer.

In case of an optical coupling, photoconductors are placed with their input and/or output surfaces in the adjoining mating surfaces of the modules that are to be coupled.

It is readily evident that the power supply and data communication can be coupled inductively, capacitively or optically in the same way or in different ways. For example, the transfer of power can take place via an inductive coupling, while the data and information transfer is accomplished by optical coupling. Similarly a capacitive transfer of power may be combined with optical data communication. All other combinations are likewise possible.

The invention is described in greater detail below based on examples of embodiment shown in the drawings, which show:

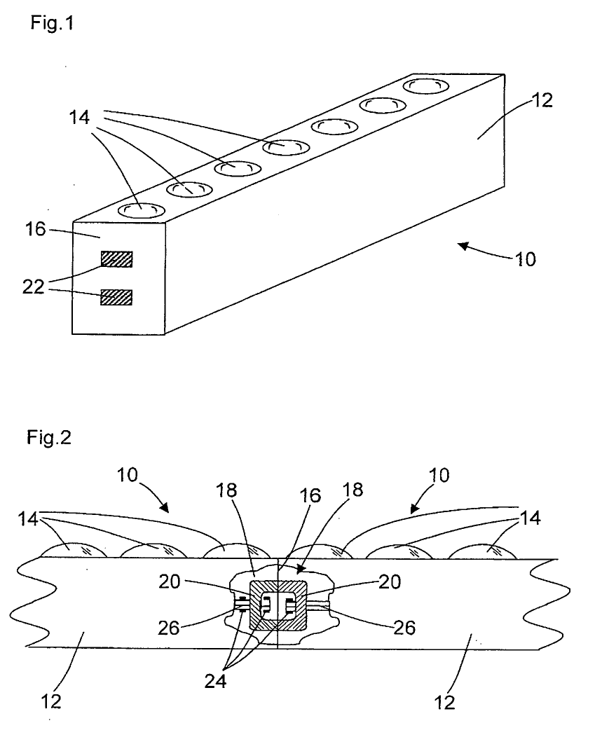

FIG. 1 a first embodiment of a module for a light grid in perspective view,

FIG. 2 a vertical partial section through two coupled modules of the first embodiment,

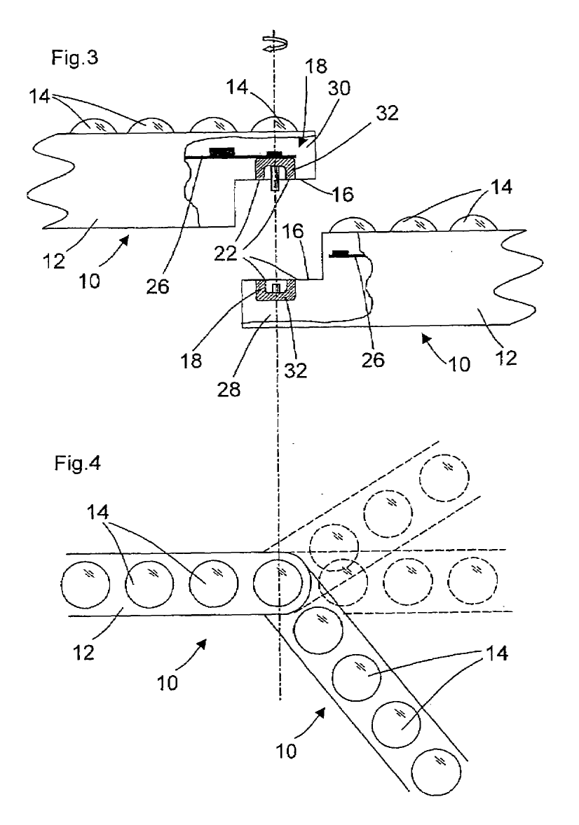

FIG. 3 a vertical partial section of the coupling between two modules in a second embodiment and

FIG. 4 a top view of the coupling of two modules in the second embodiment.

In a first embodiment, a light grid is constructed of individual modules 10, one of which is represented in FIG. 1.

The module 10 has a rectangular-shaped housing 12 enclosed on all sides in which an optoelectronic unit is present. The optoelectronic unit may be a transmitter unit or a receiver unit or a combination of a transmitter and a receiver unit. Such transmitter units and receiver units are of known state of the art. They comprise light emitting transmitter elements or light receiving receiver elements, as well as electronics for controlling these elements and for analyzing and transmitting the signals. In this example of embodiment, the module 10 is designed with an elongated housing 12 in which several transmitter and/or receiver elements are arranged in a sequence extending in the longitudinal direction of the housing 12. Only the respective optics 14 of the transmitter or receiver elements of the transmitter and/or receiver unit are visible in FIG. 1.

At the two ends of the elongated housing 12, an enclosed front surface of the housing 12 is configured as a mating surface 16, extending as a flat surface perpendicular to the longitudinal axis of the housing 12. If several modules 10 are to be joined to form a light grid, these modules 10 are joined at the mating surfaces 16 of their housings 12 so that the mating surfaces 16 of adjoined modules 10 are congruent.

A galvanically separate transducer, which is configured in the example of embodiment of FIGS. 1 and 2 as an inductive transducer, is used for purposes of transmitting the power for the transmitter and/or receiver units and for transmitting the data and information signals of a module 10 to the adjacent module. For this purpose, each module 10 has a transducer interface 18 at both ends of the mating surfaces 16. The transducer interface 18 is formed by a U-shaped magnetic core 20, which is arranged in the housing 12 in such a way that its two legs run perpendicular to the mating surface 16 and lie with their free end surfaces 22 flush against the mating surface 16. A transducer coil 24 is attached to the magnetic core 20 within the housing 12. The transducer coil 24, which in particular encloses the yoke of the U-shaped magnetic core 20, may for example be located on a printed circuit board 26 that is located in the housing 12 and holds the electronics of the transmitter and/or the receiver unit.

If two modules 10 are joined along their end mating surfaces 16, then the end surfaces 22 of the magnetic cores 20 of the transducer interfaces 18 of the two modules 10 come together in a congruent position. The magnetic cores 20 of the two modules 10 thereby join to form a circularly enclosed transducer magnetic core as shown in FIG. 2. The transducer coils 24 of the transducer interfaces 18 of the adjoining modules 10, together with the shared transducer magnetic core, form thus an inductive transducer which couples the two modules 10 to each other.

On the one hand, the data and control signals can be transmitted via this transducer. On the other hand, the power for the transmitter and/or receiver units is also transferred via this transducer. A high frequency AC voltage, e.g. with a frequency of approximately 125 kHz, which may be stochastically frequency-modulated (spread spectrum process) if necessary, is used for this purpose.

If the mating surfaces 16 are located perpendicular to the longitudinal axis of the module 10 as shown in FIGS. 1 and 2, the modules 10 can only be connected in a straight line. The respective final transmitter and/or receiver elements are preferably placed at the ends of the module 10 with their optics 14 at a distance from the mating surface 16 such that the distance between the end-side optics 14 of the adjoining modules 10 corresponds to the raster spacing of the optics 14 in the modules 10. The light grid then continues from one module to the following module at a constant raster spacing, without a loss in resolution of the light grid occurring at the transition point from one module 10 to the following module 10.

FIGS. 3 and 4 show a second design for coupling the modules 10 to produce a light grid. To the extent that this second example of embodiment agrees with the first one, the same reference numbers are used and reference is made to the foregoing description.

In the example of embodiment of FIGS. 3 and 4, the housings 12 of the modules 10 exhibit at their ends mating surfaces 16 that extend parallel to the longitudinal axis of the housing 12 and perpendicular to the direction of the light beams in the optics 14. For this purpose, the housings 10 exhibit a projection 28 extending from the bottom at one end and a projection 30 extending from the top at the other end. The lower projection 28 at one end and the upper projection 30 at the other end of the housings 12 are designed complimentary to each other in such a way that the projections 28 and 30 of adjoining modules 10 overlap and add together to the overall height of the housings 12. The respective mating surfaces 16 at the top of the lower projection 28 and at the bottom of the upper projection 30 respectively are designed to be parallel to the longitudinal axis of the housing 12. This is shown in FIG. 3, in which one module 10 is shown displaced toward the top from the following module 10.

In the housings 12, transducer interfaces 18 of an inductive transducer are located in the projections 28 and 30 respectively. Each of the transducer interfaces contains a magnetic core 32 configured as a rotationally symmetric cup core or pot core. The enclosed base of the respective magnetic cores 32 is inside the housing 12, while the rotationally symmetric free surfaces of the pot-shaped casing and the central pin of the magnetic core 32 lie flush exposed on the mating surface 16. The respective transducer coil, which is preferably connected to the printed circuit board 26, sits on the magnetic cores 32 within the housing 12. If, when joining the modules 10, the mating surfaces 16 are placed on top of each other, the open front surfaces of the magnetic cores 32 of the transducer interfaces 18 join together forming an enclosed transducer magnetic core, one of whose a transducer coils is located in one module while the other transducer coil is located in the other module. Since the magnet core 32 is configured to be rotationally symmetric, the modules 10 can be swiveled with respect to each other as shown in FIG. 4, with the axis of rotation being the rotation axis of the transducer. The interconnected modules 10 can thus assume any position with respect to each other. The central pin of the magnetic core 32 of one transducer interface 18 may in the process extend beyond the mating surface 16, while the central pin of the magnetic core 32 of the opposite transducer interface 18 is recessed into the mating surface 16. The conjoined central pins can thus simultaneously act as a rotational bearing for the swiveling motion of the modules 10.

As FIG. 3 shows, the laterally last optics 14 at one end of the modules 10 are preferably located on the upper projection 30 above the center of the axis of rotation. This allows the modules 10 to be joined to each other without an interruption of the raster spacing of the optics 14 occurring at the junction point.

### REFERENCE SYMBOL LIST

10 Modules
12 Housing
14 Optics
16 Mating surface
18 Transducer interface
20 Magnetic core
22 End surfaces
24 Transducer coil
26 Printed circuit board
28 Bottom projection
30 Top projection
32 Magnetic core

1. Light grid that may be constructed with individual modules (10), with each module (10) constituting an independently functional transmitter and/or receiver unit in an enclosed housing (12) and with the modules (10) capable of being coupled to each other in series for purposes of power and/or signal transmission, characterized by the fact that the modules (10) can be linked in a galvanically separate manner.

2. Light grid according to claim 1, characterized by the fact that the modules (10) can be linked inductively.

3. Light grid according to claim 1, characterized by the fact that the modules (10) can be linked capacitively.

4. Light grid according to claim 1, characterized by the fact that the modules (10) can be linked optically.

5. Light grid according to claim 1, characterized by the fact that the modules (10) have a transducer interface (18) at opposite ends of their housing (12), that modules (10), which are to be coupled to each other, are joined at the ends of their housings (12) in such a manner that the respective transducer interfaces (18) of these ends fit together and complement each other so as to form a transducer.

6. Light grid according to claim 5, characterized by the fact that the transducer interfaces (18) are located in mating surfaces (16) of the housing (12) so that the mating surfaces (16) of modules (10) to be coupled to one another join at their surfaces.

7. Light grid according to claim 5, characterized by the fact that the housings (12) of the modules (10) are elongated and contain at least two transmitter and/or receiver elements, which are arranged in a row parallel to the longitudinal axis of the housing (12).

8. Light grid according to claim 6, characterized by the fact that the mating surfaces (16) are located at an angle with respect to the longitudinal axis of the housing (10).

9. Light grid according to claim 6, characterized by the fact that the mating surfaces (16) are located parallel to the longitudinal axis of the housing (12) and the ends of the adjoining housings (12) overlap within the range of the mating surfaces (16).

10. Light grid according to claim 7, characterized by the fact that the adjoining housings (12) may be rotated with respect to each other in the plane of the mating surfaces (16) and that the transducers are rotationally symmetric with respect to an axis of rotation that is perpendicular to the mating surfaces (16).
